(19) United States
(12) Patent Application Publication
(10) Pub. No.: US 2026/0008509 A1
(43) Pub. Date: Jan. 8, 2026

(54) ZERO TURN RADIUS MACHINE

(71) Applicant: STEVENS PRODUCTS LIMITED, Auckland (NZ)

(72) Inventors: Brian Steven JOHNSTON, Auckland (NZ); Kenneth Mark JOHNSTON, Auckland (NZ)

(73) Assignee: STEVENS PRODUCTS LIMITED, Auckland (NZ)

(21) Appl. No.: 19/261,664

(22) Filed: Jul. 7, 2025

(30) Foreign Application Priority Data
Jul. 8, 2024 (AU) 2024902099

(51) Int. Cl. B62D 61/12; A01D 34/64; B60K 1/02; B62D 5/04; B62D 11/02

(52) U.S. Cl. CPC B62D 61/12; A01D 34/64; B60K 1/02; B62D 5/0418; B62D 11/02

(57) ABSTRACT

Disclosed is a zero turn radius (ZTR) machine (100) comprising a chassis (102) with a first pair of drive wheels (104a, 104b) mounted near the front or forward central region, and a second pair of drive wheels (106a, 106b) mounted near the rear or rearward central region, with a gap between them to facilitate zero turn operation. An elevating device near the rear end includes at least one actuator and a tail wheel configured to move between a retracted position, disengaged from the surface, and an extended position, engaged with the surface. In the extended position, the tail wheel raises the second pair of drive wheels (106a, 106b), allowing zero turn operation using only the first pair of drive wheels and the tail wheel.

### FIELD OF THE INVENTION

This invention relates to a zero turn radius (ZTR) machine. More particularly, but nor exclusively, it relates to a ZTR machine for mowing operations or a ZTR mower.

### BACKGROUND

Zero turn radius (ZTR) machines are known. A ZTR mower is one example of such machines. ZTR mowers are known for their excellent manoeuvrability and efficiency. Typically, such ZTR mowers achieve this through two independently driven drive wheels, allowing each drive wheel to move at different speeds and in different directions along with two smaller and normal swivel/castor wheels at the front that can rotate 360 degrees to further facilitate manoeuvrability of the mower. Such mowers can come in different configurations. For example, in one configuration the mower deck may be suspended between the prime mover's wheels. Similarly, in the second configuration, the deck may be positioned out front. The first configuration can risk losing control on slopes due to decreased traction on the uphill drive tire, while the front castor wheel(s) lack braking and steering capabilities, leading to dangerous, uncontrolled descents. The second configuration, although better for descending slopes, can still lose traction when climbing hills due to uneven weight distribution, compromising its safety and operational range.

Further, both configurations face challenges with flotation on wet ground. The weight distribution across two large drive wheels and smaller castor wheel(s) often causes these mowers to get stuck or leave marks or even tear the turfs in wet conditions. Moreover, operating such mowers on slopes of around 10 degrees or more can be particularly hazardous, can result in accidents and even fatalities. Applying brakes to castor wheel(s) or using dual wheels on each side of the mower can be ineffective, expensive and/or impractical. For example, applying brakes to such front castor wheels can be challenging due to design complexity, space limitations, uneven braking, increased maintenance needs, higher costs, and potential control issues during mowing operations. Similarly, using dual wheels on each side may improve traction to some degree but can make the vehicle too wide for certain applications such as mowing. This can also negatively impact or prevent edge trimming ability of the mower and therefore not desirable for mowing operations.

Alternative solutions, like remotely controlled mowers, will remove the operator from the machine but are generally more expensive and slower. Further, although removing operator means no operator injury that alone is not sufficient for improving traction or for reducing ground marks when operated in wet conditions.

Mounting mower decks on larger ZTR machines such as skid steer loaders is also not desirable, particularly because such machines designed primarily for material moving and therefore impractical for mowing operations due to their weight, cost, size, and lack of manoeuvrability. For example, material moving machines such as skid steer loaders typically weigh between 1400 and 3000 kg or even more, which is too heavy for mowing. This extra weight can damage the turf and make the mowing inefficient. Also, skid steer loaders are expensive, making them a poor choice for mowing. Their large size is not ideal for work such as mowing that requires better precision including edge trimming. Thus, while they may provide manoeuvrability that is suitable for material moving operations, they are not efficient enough for proper mowing operations including edge trimming. Other types of ZTR machines such as snow ploughs or landscaping equipment also face similar problems.

### OBJECT OF THE INVENTION

It is therefore an object of the present invention to provide a Zero turn radius (ZTR) machine which overcomes or at least ameliorates some of the disadvantages described above, or which at least provides the public with a useful choice.

Alternatively, or additionally, it is an object of the present invention to provide a Zero turn radius (ZTR) mower which overcomes or at least ameliorates some of the disadvantages described above, or which at least provides the public with a useful choice.

### BRIEF DESCRIPTION OF THE INVENTION

Accordingly, in a first aspect, the invention resides in a Zero turn radius (ZTR) machine, the machine comprising:
a chassis comprising a front end portion and a rear end portion, the front end portion is oriented in a direction of forward movement of the machine and the rear end portion is oriented in an opposite direction;
a first pair of drive wheels rotatably mounted at or near the front end portion or a forward central region of the chassis;
a second pair of drive wheels rotatably mounted at or near the rear end portion or a rearward central region of the chassis, wherein there is a gap between the first pair of drive wheels and the second pair of drive wheels for allowing zero turn radius operation of the machine; and
an elevating device mounted at or near the rear end portion of the chassis, the elevating device comprising at least one actuator for selectively transitioning between a retracted position and an extended position, the elevating device further comprising at least one tail wheel operatively connected to the at least one actuator;
wherein, when in the retracted position, the at least one tail wheel is configured to be physically disengaged from a surface on which the first pair of drive wheels and the second pair of drive wheels are supported, while both the first pair of drive wheels and the second pair of drive wheels are configured to remain in contact with the surface; and
wherein, when in the extended position the at least one tail wheel is configured to be physically engaged with the surface and positioned behind the first and second pairs of drive wheels, raising the second pair of drive wheels from the surface, thereby allowing the machine to operate in a zero turn radius mode with the at least one tail wheel and the first pair of drive wheels remaining in contact with the surface.

In one embodiment, the gap between the first and second pairs of drive is of a spacing that allows first and second paid of drive wheels while also allowing zero turn radius operation of the machine.

In one embodiment, the gap between the first and second pairs of drive wheels is minimised or substantially minimised while maintaining zero turn radius operation of the machine.

In one embodiment, the gap between the first and second pairs of drive wheels corresponds to structural minimum spacing that is necessary for maintaining zero turn radius operation of the machine. In other words, the gap between the first and second pairs of drive wheels may be or may correspond to the minimum or substantially minimum clearance/structural spacing required for allowing zero turn radius operation of the machine.

In one embodiment, at least speed of each wheel of the first pair of drive wheel and each wheel of the second pair of drive wheel are independently controllable to allow the machine to operate in the zero turn radius mode even when the elevating device is in the retracted position.

In one embodiment, the machine comprises individual motors for each wheel of the first pair of drive wheels and the second pair of drive wheels, and at least one controller that is operatively connected to the individual motors to control the direction and/or speed of each wheel of the first pair of drive wheels and the second pair of drive wheels.

In one embodiment, the elevating device is mounted at or near the rear end portion of the chassis, such that when in the extended position, the second pair of drive wheels is configured to be located between the first pair of drive wheels and at least the at least one tail wheel that engages with the surface.

In one embodiment, the at least one actuator is a hydraulic actuator.

In one embodiment, the at least one actuator is a linear actuator.

In one embodiment, the at least one actuator is a ram type actuator or a lever.

In one embodiment, the at least one actuator is mounted at or near the rear end portion of the chassis.

In one embodiment, the at least one tail wheel is rotatably mounted to the at least one actuator.

In one embodiment, the at least one tail wheel is rotatably mounted to the at least one actuator on a vertical axis to allow for 360 degrees rotation of the at least one castor wheel.

In one embodiment, the at least one tail wheel is a castor wheel.

In one embodiment, when in the extended position, the at least one tail wheel is configured to be positioned centrally behind the first and second drive wheels.

In one embodiment, the at least one tail wheel comprises a locking mechanism for locking the at least one tail wheel to a fixed position.

In one embodiment, the gap (or maximum gap) between the first pair of drive wheels and the second pair of drive wheels is less than a tire diameter of any of the drive wheels.

In one embodiment, the gap (or maximum gap) between the first pair of drive wheels and the second pair of drive wheels is less than a rim diameter of any of the drive wheels.

In one embodiment, the gap (or maximum gap) between the first pair of drive wheels and the second pair of drive wheels is less than a tire width of any of the drive wheels.

In one embodiment, the gap (or maximum gap) between the first pair of drive wheels and the second pair of drive wheels is 10 mm, 40 mm, or between 10 mm and 40 mm.

In one embodiment, the gap (or maximum gap) between the first pair of drive wheels and the second pair of drive wheels is 15 mm, or between 15 mm and 30 mm.

In one embodiment, the gap (or maximum gap) between the first pair of drive wheels and the second pair of drive wheels is between 20 mm and 30 mm.

In one embodiment, the gap (or maximum gap) between the first pair of drive wheels and the second pair of drive wheels is or about 20 mm.

In one embodiment, the gap (or maximum gap) between the first pair of drive wheels and the second pair of drive wheels is or about 21 mm.

In one embodiment, the gap (or maximum gap) between the first pair of drive wheels and the second pair of drive wheels is or about 22 mm.

In one embodiment, the gap (or maximum gap) between the first pair of drive wheels and the second pair of drive wheels is or about 23 mm.

In one embodiment, the gap (or maximum gap) between the first pair of drive wheels and the second pair of drive wheels is or about 24 mm.

In one embodiment, the gap (or maximum gap) between the first pair of drive wheels and the second pair of drive wheels is or about 25 mm.

In one embodiment, the gap (or maximum gap) between the first pair of drive wheels and the second pair of drive wheels is or about 26 mm.

In one embodiment, the gap (or maximum gap) between the first pair of drive wheels and the second pair of drive wheels is or about 27 mm.

In one embodiment, the gap (or maximum gap) between the first pair of drive wheels and the second pair of drive wheels is or about 28 mm.

In one embodiment, the gap (or maximum gap) between the first pair of drive wheels and the second pair of drive wheels is or about 29 mm.

In one embodiment, the gap (or maximum gap) between the first pair of drive wheels and the second pair of drive wheels is or about 30 mm.

In one embodiment, during a straight and forward movement of the machine, a rotational axis of the first pair of drive wheels is parallel to a rotational axis of the second pair of drive wheels.

In one embodiment, size of the first pair of drive wheels is same or substantially the same as size of the second pair of drive wheels.

In one embodiment, size of the at least one tail wheel is smaller than the size of the first pair of drive wheels and the size of the second pair of drive wheels.

In one embodiment, the first pair of drive wheels are drivable (configured to be driven) by a chain drive mechanism.

In one embodiment, the second pair of drive wheels are drivable (configured to be driven) by a chain drive mechanism.

In one embodiment, the first pair of drive wheels are drivable (configured to be driven) by a belt drive mechanism.

In one embodiment, the second pair of drive wheels are drivable (configured to be driven) by a belt drive mechanism.

In one embodiment, the first pair of drive wheels are drivable (configured to be driven) by either a chain drive mechanism or a belt drive mechanism.

In one embodiment, the second pair of drive wheels are drivable (configured to be driven) by either a chain drive mechanism or a belt drive mechanism.

In one embodiment, the first pair of drive wheels are drivable (configured to be driven) by a chain drive mechanism connected to the second pair of drive wheels for transferring power from the second pair of drive wheels to the first pair of drive wheels.

In one embodiment, the first pair of drive wheels are drivable (configured to be driven) by a separate transmission system for transferring power to the first pair of drive wheels.

In one embodiment, the second pair of drive wheels are drivable (configured to be driven) by a chain drive mechanism connected to the first pair of drive wheels for transferring power from the first pair of drive wheels to the second pair of drive wheels

In one embodiment, the second pair of drive wheels are drivable (configured to be driven) by a separate transmission system for transferring power to the second pair of drive wheels.

In one embodiment, the first pair of drive wheels and second pair of drive wheels are mounted to the chassis at or near centre region of the chassis.

In one embodiment, the machine further comprises a utility deck that is mounted to the chassis and is positioned in front of the first pair of drive wheels and the second pair of drive wheels.

In one embodiment, the utility deck is mounted to the chassis by at least one arm.

In one embodiment, the at least one arm is spring loaded to pivot and transfer at least some weight from the utility deck to the first pair of drive wheels.

In one embodiment, the utility deck is positioned in front of and below the chassis and is pivotally mounted to at least one arm that is connected to the chassis, with a spring or a gas strut exerting a pulling force on the at least one arm to partially lift the utility deck, thereby transferring or redistributing weight towards the first pair of drive wheels that are front drive wheels and reducing the load on the second pair of drive wheels that are rear drive wheels.

In one embodiment, the machine further comprises at least one swivel wheel (more preferably a pair of swivel wheels) that is rotatably mounted to a front end portion of the utility deck for further facilitating the manoeuvrability of the machine.

In one embodiment, the at least one swivel wheel (more preferably a pair of swivel wheels) are rotatably mounted to the front portion of the utility deck on a vertical axis to allow for 360 degrees rotation of the at least one tail wheel.

In one embodiment, the machine is a mower.

In one embodiment, the utility deck is a mower deck.

In one embodiment, the mower is a ride on mower.

In one embodiment, at least one cutting blade of the mower is mounted to the mower deck or to the utility deck.

In one embodiment, the mower deck or the utility deck comprises at least one anti-scalp wheel that is rotatably and pivotally mounted to the mower deck or to the utility deck.

In one embodiment, the utility deck comprises at least one anti-scalp wheel that is rotatably and pivotally mounted to the utility deck or to a mower housing that is mounted to or is part of the utility deck.

In one embodiment, the Zero turn radius (ZTR) machine further comprises at least one sensor for detecting terrain conditions and a control system that is operatively connected to the elevating device and the at least one sensor to automatically adjust the position of the elevating device based on terrain conditions.

In one embodiment, the ZTR machine comprises a seat that is mounted to and above the chassis for an operator to sit on.

In one embodiment, the seat is located directly above the first pair of drive wheels.

In one embodiment, the seat is located more proximal to the front end portion of the chassis than the rear end portion of the chassis.

In one embodiment, an engine of the ZTR machine is mounted to and above the chassis.

In one embodiment, the engine is located directly above the second pair of drive wheels.

In one embodiment, the engine is located more proximal to the rear end portion of the chassis than the front end portion of the chassis.

In a second aspect, the invention resides in a Zero turn radius (ZTR) mower or a ZTR machine that is a mower comprising:
a chassis comprising a front end portion and a rear end portion, the front end portion is oriented in a direction of forward movement of the prime mover and the rear end portion is oriented in an opposite direction;
a first pair of drive wheels rotatably mounted at or near the front end portion or a forward central region of the chassis;
a second pair of drive wheels rotatably mounted at or near the rear end portion or a rearward central region of the chassis, wherein there is a gap between the first pair of drive wheels and the second pair of drive wheels for allowing zero turn radius operation of the machine; and
an elevating device mounted at or near the rear end portion of the chassis, the elevating device comprising at least one actuator for selectively transitioning between a retracted position and an extended position, the elevating device further comprising at least one tail wheel operatively connected to the at least one actuator,
wherein, when in the retracted position the at least one tail wheel is configured to be physically disengaged from a surface on which the first pair of drive wheels and the second pair of drive wheels are supported, while both the first pair of drive wheels and the second pair of drive wheels are configured to remain in contact with the surface; and
wherein, when in the extended position the at least one tail wheel is configured to be physically engaged with the surface and positioned behind the first and second pairs of drive wheels, raising the second pair of drive wheels from the surface, thereby allowing the mower to operate in a zero turn radius mode with the at least one tail wheel and the first pair of drive wheels remaining in contact with the surface; and
wherein, the mower further comprises a utility deck that is a mower deck mounted to the chassis and is positioned in front of the first pair of drive wheels and the second pair of drive wheels, the mower deck being mounted to the chassis by at least one arm that is spring loaded to pivot and transfer at least some weight from the mower deck to the first pair of drive wheels.

In a third aspect, the invention resides in a zero turn radius (ZTR) machine, comprising:
a chassis comprising a front end portion and a rear end portion or a forward central region;
a first pair of drive wheels mounted at or near the front end portion or a rearward central region of the chassis;
a second pair of drive wheels mounted at or near the rear end portion of the chassis; and
an elevating device mounted near the rear end portion of the chassis, the elevating device comprising at least one actuator and at least one tail wheel operatively connected to the at least one actuator;
wherein the actuator is configured to transition the elevating device between a retracted position, where the at least one tail wheel is configured to be disengaged from a surface that is a supporting surface, and an extended position, where the at least one tail wheel is configured to be engaged with the supporting surface and the second pair of drive wheels lifted from the surface, allowing a zero turn radius operation with the first pair of drive wheels and the at least one tail wheel in contact with the surface.

In a fourth aspect, the invention resides in a Zero turn radius (ZTR) mower or a ZTR machine that is a mower, the mower comprising or in a form of a prime mover, the prime mover comprising:
a chassis comprising a front end portion and a rear end portion, the front end portion is oriented in a direction of forward movement of the prime mover and the rear end portion is oriented in an opposite direction;
a first pair of drive wheels rotatably mounted at or near the front end portion or a forward central region of the chassis;
a second pair of drive wheels rotatably mounted at or near the rear end portion or a rearward central region of the chassis, wherein there is a gap between the first pair of drive wheels and the second pair of drive wheels for allowing zero turn radius operation of the machine; and
an elevating device mounted at or near the rear end portion of the chassis, the elevating device comprising at least one actuator for selectively transitioning between a retracted position and an extended position, the elevating device further comprising at least one tail wheel operatively connected to the at least one actuator,
wherein, when in the retracted position the at least one tail wheel is configured to be physically disengaged from a surface on which the first pair of drive wheels and the second pair of drive wheels are supported, while both the first pair of drive wheels and the second pair of drive wheels are configured to remain in contact with the surface; and
wherein, when in the extended position the at least one tail wheel is configured to be physically engaged with the surface and positioned behind the first and second pairs of drive wheels, raising the second pair of drive wheels from the surface, thereby allowing the mower to operate in a zero turn radius mode with the at least one tail wheel and the first pair of drive wheels remaining in contact with the surface; and
wherein, the mower further comprises a utility deck that is a mower deck mounted to the chassis and is positioned in front of the first pair of drive wheels and the second pair of drive wheels, the mower deck being mounted to the chassis by at least one arm that is spring loaded to pivot and transfer at least some weight from the mower deck to the first pair of drive wheels.

In a fifth aspect, the invention resides in a method of operating a zero turn radius (ZTR) machine as defined in any one or more of the statements above, the method comprising:
providing the machine as defined in any one or more of the statements above;
transitioning the elevating device between a retracted position, where the at least one tail wheel is disengaged from the surface, and an extended position, where the at least one tail wheel is engaged with the supporting surface and the second pair of drive wheels is lifted from the supporting surface; and
enabling zero turn radius operation with the first pair of drive wheels and the at least one tail wheel in contact with the surface.

In one embodiment, the method further comprises independently controlling at least a speed of each wheel of the first pair of drive wheel and each wheel of the second pair of drive wheel thereby allowing the machine to operate in a zero turn radius mode even when the elevating device is in the retracted position.

In any of the above aspects, one or more statements relating to any one aspect may equally apply to any other aspect.

As used hereinbefore and hereinafter and unless stated otherwise, the word ‘for’ is to be interpreted to mean only ‘suitable for’, and not for example, specifically ‘adapted’ or ‘configured’ for the purpose that is stated.

As used hereinbefore and hereinafter and unless stated otherwise ‘and/or’ means ‘and’ or ‘or’ or both.

As used hereinbefore and hereinafter and unless stated otherwise, the term ‘wheel’ may include ‘a wheel assembly’ and the term ‘wheels’ may include ‘wheel assemblies’.

As used hereinbefore and hereinafter and unless stated otherwise, “(s)”, following a noun means the plural and/or singular forms of the noun.

As used hereinbefore and hereinafter and unless stated otherwise, ‘mounted’ or ‘connected’, means ‘directly or indirectly mounted’. For example, it may include directly mounted but may also include mounted using/through another member(s) or component(s).

As used hereinbefore and hereinafter and unless stated otherwise, ‘gap’ refers to a spacing that is of a minimal or substantially minimal structural spacing while sufficient to allow zero turn radius operation of the machine.

As used herein and hereinafter and unless stated otherwise, ‘minimal or substantially minimal structural spacing’ refers to a spacing that equals or closely approximates the smallest clearance structurally necessary between the front and rear drive wheel pairs, sufficient to maintain chassis integrity and enable independent, opposing wheel rotation required for zero-turn operation. The term accommodates minor deviations (e.g. due to design tolerances or manufacturing constraints) but excludes any spacing that is not structurally or operationally justified.

As used herein and hereinafter and unless stated otherwise, ‘zero turn radius mode’ refers to mode where zero turn radius operation of the machine is enabled.

As used hereinbefore and hereinafter and unless stated otherwise, ‘connected’, means ‘directly or indirectly connected’. For example, it may include directly connected but may also include connected using/through another member(s) or component(s).

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following description are simply exemplary embodiments of the invention. Hence, specific dimensions and other physical characteristics related to the embodiments disclosed herein are not to be considered as limiting.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e., that it will be taken to mean an inclusion of not only the listed components it directly references, but also other non-specified components or elements. This rationale will also be used when the term ‘comprised’, ‘comprises’ or ‘comprising’ is used in relation to one or more steps in a method or process.

It is known to those with skill in the art of patenting, that the word ‘substantially’ can in some instances, be used to broaden a term. It should be stated that, in this specification, use of the word ‘substantially’ with a term, to define a feature(s), gets all the benefit (i.e., the benefit of broadening) afforded by the use of the word ‘substantially’, and also includes within its scope feature(s) being that the term exactly (without broadening). For example, if a feature is described/defined in this specification as being ‘substantially vertical’, then that includes, within its scope, the feature being ‘close’ to vertical (in so far as the word ‘substantially’ is deemed to broaden the term ‘vertical’), and also includes within its scope the features being ‘exactly’ vertical.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications may be referred to herein; this reference does not constitute an admission that any of these documents form part of the common general knowledge in the art, in New Zealand or in any other country.

### BRIEF DESCRIPTION OF THE DRAWINGS

Further aspects of the present invention will become apparent from the following description which is given by way of example only and with reference to the accompanying drawings in which:

FIG. 1 is a rear perspective view of Zero turn radius (ZTR) machine according to one example of the present invention showing an elevating device in a retracted position

FIG. 2 is a rear perspective view of the ZTR machine of FIG. 1 showing the elevating device in an extended position.

FIG. 3 is a front perspective view of the ZTR machine according to FIG. 1.

FIG. 4 is a rear view of the ZTR machine of FIG. 1 showing the elevating device in a retracted position.

FIG. 5 is a rear view of the ZTR machine of FIG. 1 showing the elevating device in an extended position.

FIG. 6 is a side elevation view the ZTR machine of FIG. 1 located on top of a surface with the elevating device being in a retracted position.

FIG. 7 is a side elevation view the ZTR machine of FIG. 1 located on top of a surface with the elevating device being in an extended position.

FIG. 8 is a rear perspective view of the ZTR machine of FIG. 1 showing the tail wheel of the elevating device in an extended and right turn position.

FIG. 9 is a rear perspective view of the ZTR machine of FIG. 1 showing the tail wheel of the elevating device in an extended and left turn position.

FIG. 10 is a side elevation view the ZTR machine of FIG. 1 exposing the drive chain.

FIG. 11 is a side elevation view the ZTR machine of FIG. 1 exposing the pivot point of an arm connecting to the utility deck.

FIG. 12 is a schematic view showing an example where the drive wheels is mounted to the chassis at or proximal to the centre region of the chassis.

FIG. 13 is a partial side elevation view of Zero turn radius (ZTR) machine according to another example of the present invention showing an elevating device in a retracted position.

FIG. 14 is a partial side elevation view of the ZTR machine of FIG. 12 showing the elevating device in an extended position.

### DETAILED DESCRIPTION

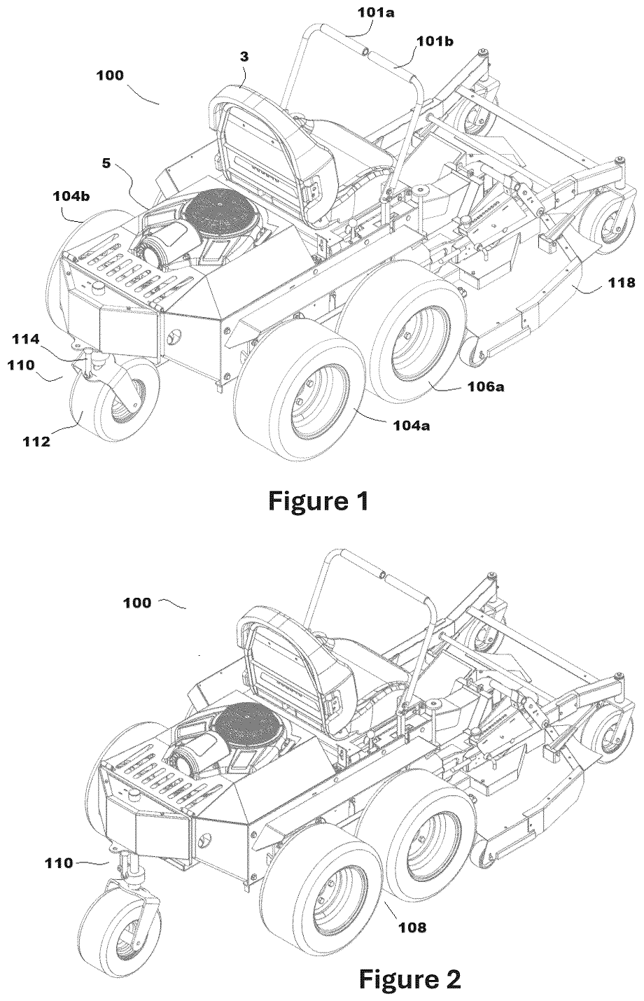

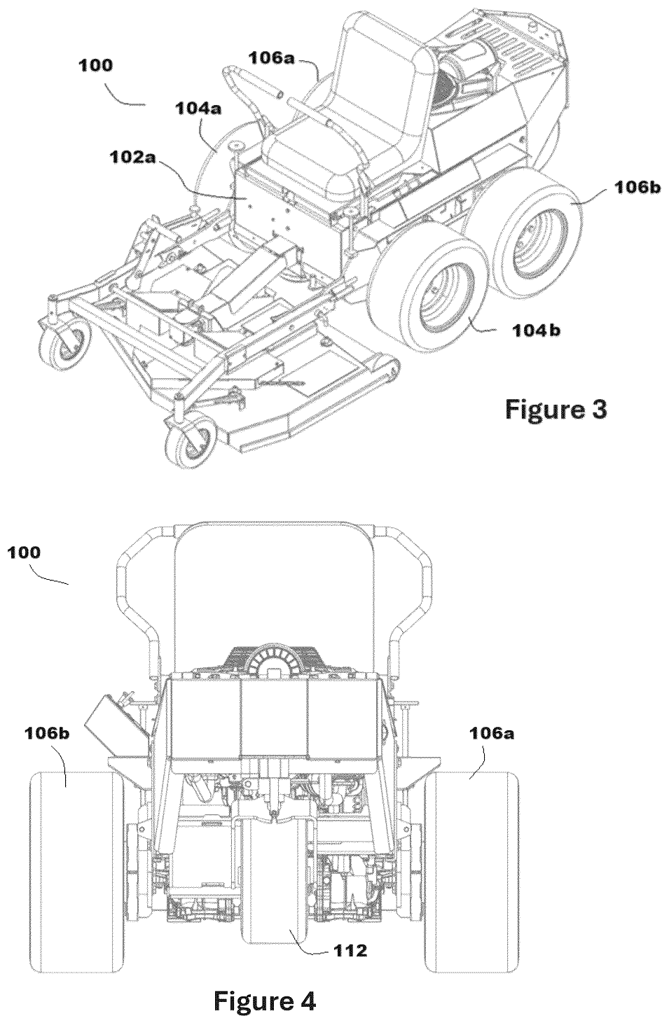

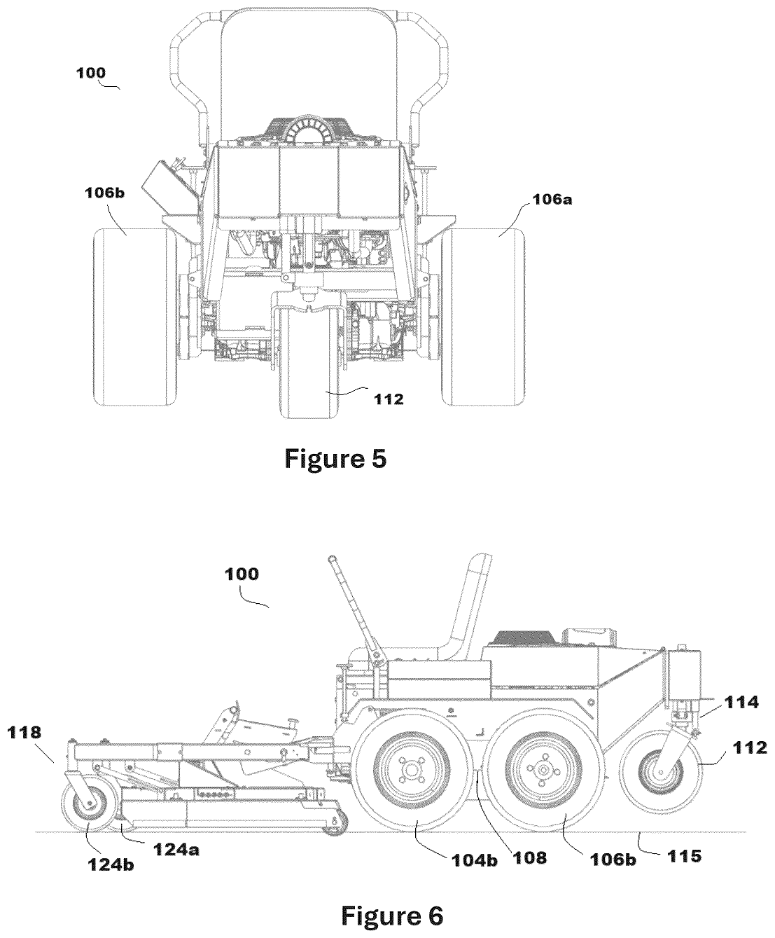

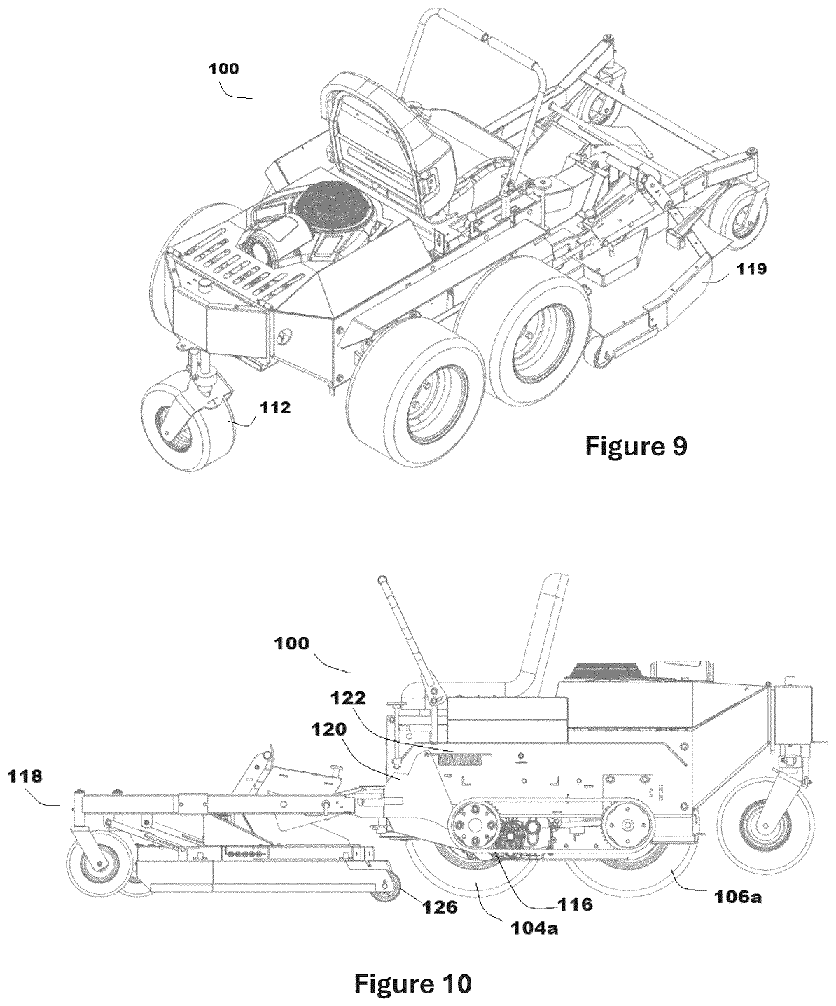

With reference to FIGS. 1 to 12, an example of a Zero turn radius (ZTR) machine (100) according to the present invention will now be described. The machine in this example is a mower more specifically, a ZTR mower or a ZTR ride on mower.

A zero turn (ZTR) machine (100) operates using a differential steering system, where at least the speeds of the drive wheels are adjusted to steer the machine (100). As a non-limiting example, the machine (100) may be controlled by two levers (101a, 101b), which may extend on either side and preferably over the lap of an operator seated on a seat (3). When both levers (101a, 101b) are pushed forward with equal force, the machine (100) may move straight ahead. Pulling both levers (101a, 101b) back with equal force may cause the machine (100) to move in reverse. To make a gentle turn, one lever may be pushed more than the other. For a zero radius turn, one lever may be pushed forward while the other is pulled back, causing the machine to pivot around its drive wheels. Alternatively, many other suitable steering mechanisms and methodologies may be used.

The Zero Turn Radius (ZTR) machine (100) comprises a chassis (102) having a front end portion (102a) oriented in the direction of forward movement and a rear end portion (102b) oriented in the opposite direction.

At or near the front end portion (102a) of the chassis (102), there is a first pair of drive wheels (104a, 104b) that are rotatably mounted. Thus, these first drive wheels (104a, 104b) may rotate freely, allowing the machine to move forward and backward. Similarly, a second pair of drive wheels (106a, 106b) may be mounted at or near the rear end portion (102b) of the chassis (102). These second pair of drive wheels (106a, 106b) may also rotate freely, enabling the machine to be driven in reverse or to perform complex manoeuvres. There is a gap (108) between these two pairs of drive wheels. The gap is of a minimal or substantially minimal structural spacing while sufficient to allow zero turn radius operation of the machine. In other words, the gap (108) corresponds to structural minimum spacing that is necessary for maintaining zero turn radius operation of the machine So, the gap (108) may correspond to the minimum or substantially minimum clearance required for allowing zero turn radius operation of the machine. Thus, the gap may be minimised or substantially minimised whilst ensuring that the machine still retains its functionality as a ZTR machine. Keeping this gap (108) that way, i.e. minimal (e.g., as small as required for maintaining zero turn radius operation of the machine) provides a technical advantage as it allow for tighter turning radii thereby improving the manoeuvrability of the machine (100), while still supporting weight of the machine (100) and providing stability during operation. Keeping this gap to a minimum also prevents or significantly lessens damage to the surface or ground on which the machine is located while the machine makes zero radius turns. The closer the drive wheels are to each other, the less scuffing occurs during turns. This is due to the fact that, in ZTR machines, none of the drive wheels pivots in the direction of the turn and they only rotate forwards or backwards to facilitate the turn.

At or near a rear end portion of the chassis (102) an elevating device (110) is mounted. This elevating device (110) comprises at least one tail wheel and at least one actuator (114). The tail wheel(s) (112) is/are most preferably a castor wheel(s). However, may be selected from many other wheels. For example, it may be a wheel whose steering and/or braking can be controlled by an operator, and/or it may be a further drive wheel. However, it is most preferred that the tail wheel (112) is a castor wheel especially for reducing design complexities and costs. The tail wheel (112) may be operatively connected to the actuator (114). The actuator (114) may be a mechanical component that can extend or retract, altering the position of the tail wheel (112). The elevating device (110) is configured to selectively transition between a retracted position as shown in FIG. 1 and an extended position as shown in FIG. 2. In the retracted position/condition, the tail wheel (112) is disengaged (i.e., physically disengaged) from the surface, meaning it does not touch the surface (115)/supporting surface (115) (e.g. a ground). This can be more clearly seen in FIG. 6. During this retracted position, both pairs of drive wheels remain in contact with the surface (115). This means that during the retracted position the machine can operate in a four-wheel drive/all-wheel drive mode, i.e., 4WD/AWD mode thereby significantly better traction on many different types of terrains and degrees of slopes as compared to conventional two-wheel drive ZTR machines. Having four drive wheels can also reduce the ground pressure on each wheel as the weight of the machine is spread over more footprint. Therefore, the machine (100) does not sink into the wet ground with such an arrangement.

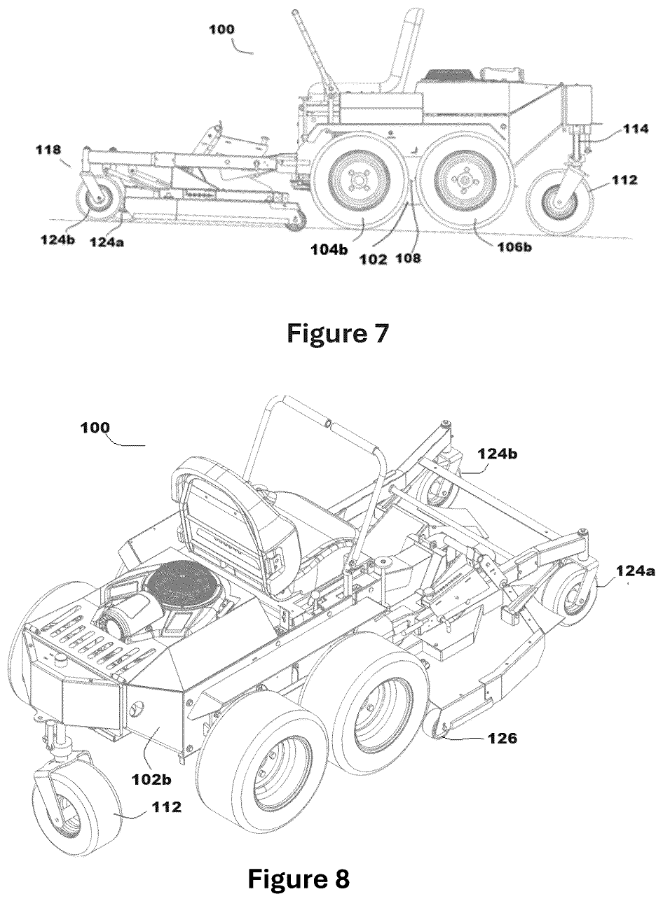

However, when the elevating device (110) transitions to the extended position, the tail wheel (112) engages with the surface (115), raising the second pair of drive wheels (106a, 106b) from the surface (115), i.e., lifted the second pair of drive wheels (106a, 106b) off the ground. This can be more clearly seen in FIG. 7. This action allows the machine to operate in a zero turn radius mode with only the tail wheel (112) and the first pair of drive wheels (106a, 106b) remaining in contact with the surface (115). This action provides significant technical advantages, as the friction and resistance provided by the second pair of drive wheels (106a, 106b) are removed, which means any damage to the surface (115) that may occur due to the friction and resistance of the drive wheels will be significantly reduced. Not only this, the ZTR machine (100) can pivot only on the first drive wheels located at the front and the tail wheel (112) located at the rear enabling sharper and more precise turns which can be very important if the machine is intended for mowing operations. Further, since the drive wheels, whose speed and direction can still be controlled by the operator are still located at the front and the tail wheel(s) is/are located at the back, there is significantly more control and traction when the surface is a slope, and the machine (110) is travelling downwardly on the slope and making such turns. This also ensures that the front drive wheels, which maintain traction, bear the machine's weight when descending on the slope, providing necessary traction and grip and prevent slipping. The rear tail wheel (114) (while not affecting the speed or direction especially if it is a castor wheel) will still ensure that the machine (100) is steady and balanced and will still aid in turning, thereby improving the overall control and safety of the machine in challenging terrains.

Each wheel of the first pair of drive wheels (104a, 104b) and each wheel of the second pair of drive wheels (106a, 106b) may be independently controlled in terms of the speed and/or rotational direction of the wheels. The operator may be able to control such movement of each wheel separately. This can allow the machine (100) to operate in a zero turn radius mode even when the elevating device (110) is in the retracted position.

In other words, when the elevating device is in the retracted position, all four drive wheels will remain in contact with the surface/ground. With independent control over the rotational direction and/or speed of each wheel, the machine (100) can still achieve zero turn radius movements. This may be achieved by adjusting the wheels to rotate in opposite directions (e.g., for example some wheels may rotate in forward direction, some may rotate in the rearward direction) and/or at varying speeds, allowing the machine to pivot in place without raising the second pair of the drive wheels (106a, 106b). This can be useful especially in situations where maintaining traction is important, but a sharp turn is not required, and where the risk of surface damage from the friction and resistance of the drive wheels is minimal. For example, on dry ground, which is less susceptible to turf or similar damage compared to wet ground.

In one example, the machine may comprise individual motors for each drive wheel in both the first and second pairs of drive wheels (104a, 104b, 106a, 106d). One or more controllers may be operatively connected such motors, for controlling the direction and/or speed of each wheel independently.

The elevating device (110) may be mounted at or near the rear end portion of the chassis (102), such that when in the extended position, the second pair of drive wheels (106a, 106b) is located between the first pair of drive wheels (104a, 104b) and the tail wheel (112) of the elevating device (110).

The actuator (114) is most preferably a hydraulic actuator. As a skilled person will appreciate, the hydraulic actuator will provide a powerful operation for heavy-duty tasks e.g., mowing or slow ploughing. However, in some examples the actuator (114) may be a pneumatic actuator or other suitable electronic actuator. The actuator may be a linear actuator. The linear actuator may provide control by converting rotational motion into linear motion. The actuator may be a ram/ram-type actuator or a lever.

The actuator (114) may be mounted at or near the rear end portion of the chassis (102). The tail wheel (112) may be rotatably mounted to the actuator (114), preferably on a vertical axis to allow for 360 degrees rotation of the tail wheel (112). In other words, the tail wheel (112) may freely turn in any direction around 360 degrees.

When the elevating device (110) is in extended position, the tail wheel (112) may be centrally positioned behind the first drive wheels (104a, 104b) and second drive wheels (106a, 106b). Such orientation of the tail wheel (112) helps to ensure a balanced support and even weight distribution, thereby improving the stability of the machine (100). A non-centre position of the tail wheel (110) on the other hand could potentially result in uneven weight distribution and less stable turns when the elevating device (110) is in the extended position.

The tail wheel (110) may comprise a locking mechanism for locking it to a fixed position. Many suitable locking mechanisms may be used for that purpose.

As mentioned above, the gap (108) between the first pair of drive wheels (104a, 104b) and the second pair of drive wheels (106a, 106b) is minimised whilst ensuring that the machine still retains its functionality as a ZTR machine. This gap (108) may be less than the diameter of any of the drive wheel tires or less than the diameter of any of the drive wheel rims or less than the width of any of the drive wheel tires. Reducing the gap (108) in such a manner will ensure that the drive wheels are positioned closely together, and the inventors have found that such reduction of the gap (108) will significantly improve the machine's ability to perform tight turns and zero turn manoeuvres by minimising the distance between the first and second pair of drive wheels (104a, 104b, 106a, 106b). In addition, such reduction of the gap (108) can also significantly reduce the scuffing of the surface/ground.

It is most preferred that this gap (108) is between 20 mm and 30 mm as the inventor has found such range to be optimal for providing such advantages as discussed above. However, this range may also be approximately/substantially 10 mm, 15 mm, 40 mm, between 10 mm and 40 mm or between 15 mm and 30 mm and still sufficiently provide these advantages. The most preferred measurements for this gap (108) are approximately/substantially 20 mm, 21 mm, 22 mm, 23 mm, 24 mm, 25 mm, 26 mm, 27 mm, 28 mm, 29 mm, and 30 mm.

During a straight and forward movement of the machine (100), a rotational axis of the first pair of drive wheels (104a, 104b) may be parallel to a rotational axis of the second pair of drive wheels (106a, 106b). This can allow the drive wheels to move forward efficiently without dragging or misalignment thereby helping the machine (100) to remain stable during its movement.

The size of the first pair of drive wheels (104a, 104b) may be same or substantially the same as size of the second pair of drive wheels (106a, 106b).

The first pair of drive wheels (104a, 104b) may be powered by a chain drive system/mechanism (116). Similarly, the second pair of drive wheels (106a, 106b) may or may also be powered by a chain drive system/mechanism (116). An example is shown in FIG. 10. Alternatively, the first pair of drive wheels (104a, 104b) may be driven by a belt drive system/mechanism. The second pair of drive wheels (106a, 106b) may or may also be driven by a belt drive system/mechanism. Details of how a chain drive system/mechanism and a belt drive system/mechanism work will be known to a person skilled in the art and therefore need not be explained in further detail. Also, a person skilled in the art will appreciate, the chain drive systems/mechanisms will provide a strong power transmission and durability and can provide many other inherent advantages of such systems/mechanism. Similarly, the belt drive system will be less noisy and require less/low-cost maintenance and can provide many other inherent advantages of the belt drive systems/mechanisms.

The first pair of drive wheels (104a, 104b) may be powered by a chain drive system/mechanism (116) that transfers power from the second pair of drive wheels (106a, 106b). This can provide synchronised movement of the wheels. Alternatively, the first pair of drive wheels (104a, 104b) may be powered by a separate chain drive or transmission system for transferring power directly to them. This can allow independent control of the transmission power of the wheels. Most preferably, the second pair of drive wheels (106a, 106b) may be driven by a chain drive system/mechanism for transferring power from the first pair of drive wheels (104a, 104b). Again, this can provide synchronised movement of the wheels Alternatively, the second pair of drive wheels (106a, 106b) may be powered by their own separate chain drive or transmission system. Again, this can allow independent control of the transmission power of the wheels.

The first pair of drive wheels (104a, 104b) and the second pair of drive wheels (106a, 106b) may be mounted to the chassis (102) at or proximal to the centre region (117) of the chassis (102). For example, the first pair of drive wheels (104a, 104b) may be rotatably mounted at the forward central region (117a) of the chassis. Similarly, a second pair of drive wheels may be rotatably mounted at or near the rearward central region (117b) of the chassis (102). Such arrangement helps ensure that that the centre of gravity is optimally located by evenly distributing the weight of the machine 100) evenly on all four wheels when all wheels are in contact with the surface (115), thereby improving the stability and traction, which in turn reduces the risk of tipping and improves control, especially when operating the machine on slopes (ascending or descending on the slopes), and especially on the slopes that are angled 10 degrees or more. Suitable tread pattern(s) may be present in the tires of the drive wheels and/or the tail wheel(s) to even further improve the traction.

The machine may further comprise a utility deck (118). The utility deck may be mounted to the chassis (102) and may be positioned in front of both the first pair of drive wheels (104a, 104b) and the second pair of drive wheels (106a, 106b). Such arrangement can allow the utility deck (118) to be located at the front part of the machine (100) so that the drive wheels can provide necessary traction and support from behind.

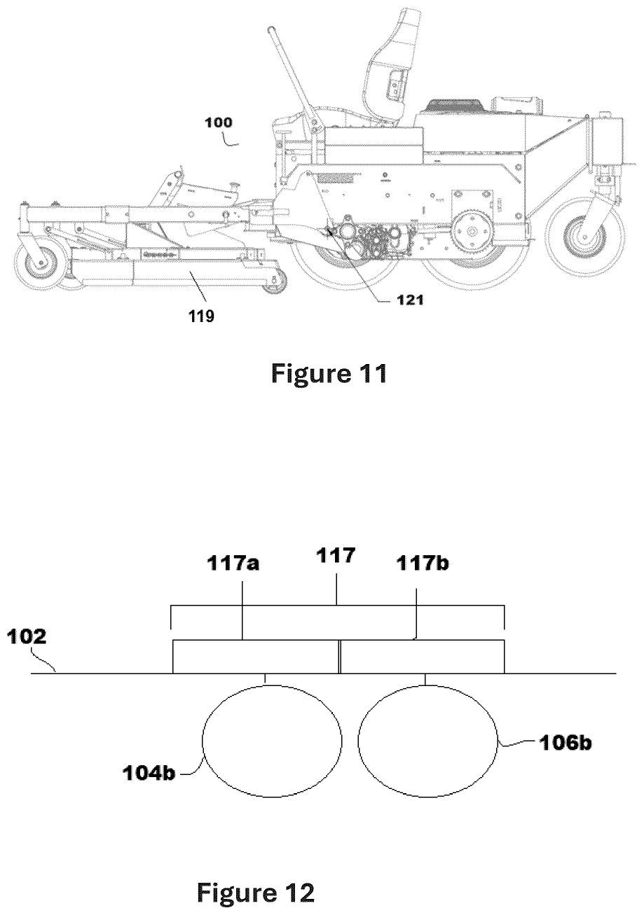

The utility deck (118) may be mounted to the chassis (102) by at least one arm (120), more preferably each arm on each lateral side of the chassis (120). This arm (120) is preferably spring-loaded to pivot and transfer at least some of the weight from the utility deck (118) to the first pair of drive wheels (104a, 104b). Spring (122) may be used for such a purpose. The pivot point (121) of the arm (120) is shown in FIG. 11. Alternatively, or additionally, a gas strut may be used. With such an arrangement, the first pair of drive wheel (104a, 104b) may experience an increase in downward force and may grip more strongly to the surface (115) due to the increased friction, thereby providing an improved traction. Such improved traction can help prevent slippage, especially on uneven or slippery surfaces including slopes, and can provide better stability of the machine (100) during operation. The more balanced weight distribution can also reduce the load on the second pair of drive wheel (106a, 106b) providing better stability and control of the machine (100).

The utility deck (118) may be positioned in front of and below the chassis (102) and may be pivotally mounted to at least one arm (120), more preferably each arm on each lateral side of the chassis (120). The arm (120) may be connected to/mounted to the chassis with the spring (122) or a gas strut exerting a pulling force on the arm (120) to partially lift the utility deck, thereby transferring or redistributing weight towards the first pair of drive wheels (104a, 104b) that are front drive wheels and reducing the load on the second pair of drive wheels (106a, 106b) that are rear drive wheels. Such arrangement can provide better traction and control of the machine (100) as already described above.

The machine (100) may further comprise at least one swivel wheel, preferably a pair of swivel wheels (124a, 124b), mounted on the front end of the utility deck (118). These swivel wheels (124a, 124b) may be configured to rotate 360 degrees on a vertical axis. In other words, the swivel wheels (124a, 124b) may freely turn in any direction around 360 degrees. By having such swivel wheels (124a, 124b) the machines may be much easier to manoeuvre especially around tight spaces and much easier to turn sharply, with less effort on part of the operator especially in areas with lots of obstacles.

As already mentioned above, it is most preferred that the machine is a mower more specifically, a ZTR mower or a ZTR ride on mower. The utility deck 118 may be the mower deck. The mower deck may house the at least one cutting blade of the mower. The mower deck may comprise a mower housing (119) for housing the mower blade(s). The mower housing (119) may be mounted to or may be part of the utility deck The cutting blade of the mower may be mounted to the mower deck for the mower deck to perform mowing operations.

The utility deck (118) or the mower deck may comprise at least one anti-scalp wheel (126), more preferably a plurality of anti-scalp wheels. The anti-scalp wheel(s) (126) may be rotatably and pivotally mounted to the utility deck or to the mower housing (119) for preventing the mower blades or similar for cutting or performing similar operation grass too closely to the ground/surface (115). For mowing operations, that can further help protecting the ground from damage and for ensuring a more even cut.

The machine (100) may further comprise at least one sensor for detecting terrain conditions and a control system. The control system may be operatively connected to the elevating device (110) and the sensor to automatically adjust the position of the elevating device (110) based on terrain conditions.

As shown, the seat (3) may be mounted to and above the chassis for an operator to sit on. The seat is most preferably located directly above the first pair of drive wheels (104a, 104b). The seat (3) may be located more proximal to the front end portion of the chassis than the rear end portion of the chassis.

An engine (5) of the machine (100) may be mounted to and above the chassis (102). The engine (5) is most preferably located directly above the second pair of drive wheels (106a, 106b). The engine (5) may be located more proximal to the rear end portion of the chassis (102) than the front end portion of the chassis (102).

Positioning the seat (3) directly above the first pair of drive wheels (104a, 104b) and closer to the front of the chassis (102) can help balance the centre of mass towards the front. Similarly positioning the engine (3) above the second pair of drive wheels (106a, 106b) near the rear of the chassis may also improve weight distribution, thereby improving the traction and overall stability, particularly on uneven terrain. Additionally, separating the seat (3) from the engine (5), rather than positioning it directly above the engine (4), can help reduce the operator's exposure to engine vibrations and noise, thereby increasing comfort during extended use. Similarly, mounting the utility deck at the front and below the chassis (102) rather than near the seat can further reduce the operator's exposure to the vibrations and noise from the utility deck (e.g., mower blades present in the utility deck).

The overall weight of the machine (100) may be approximately less than 1000 kg, most preferably, the weight of the machine (100) may be between 150 kg and 850 kg, most preferably between 250 kg and 750 kg.

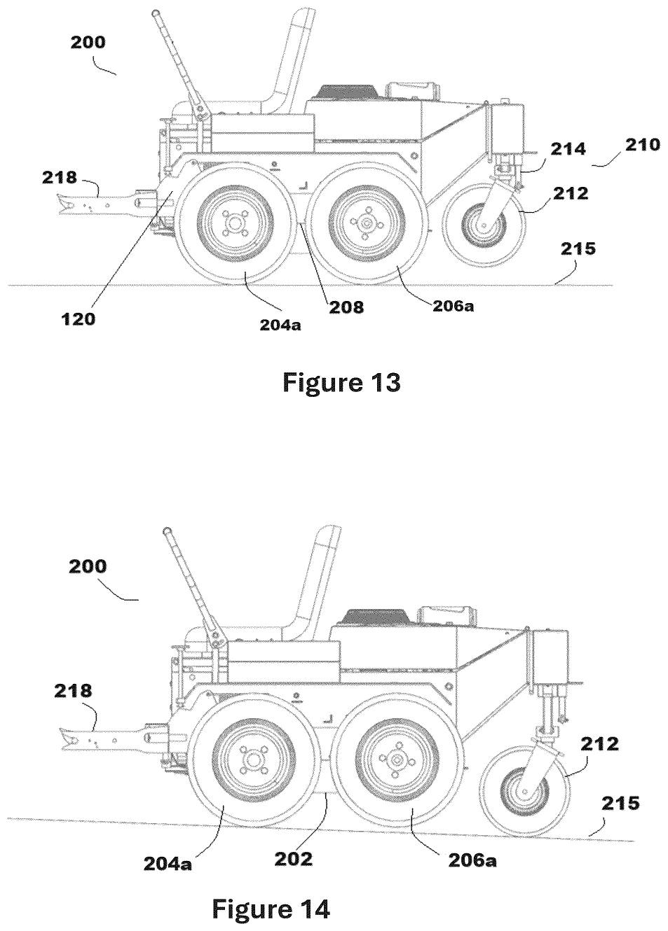

FIG. 13 is a partial side elevation view of a zero turn radius (ZTR) machine (200) according to another example of the present invention, illustrating the elevating device (210) in a retracted position. FIG. 14 shows the ZTR machine (200) of FIG. 13 where the same elevating device (210) in an extended position.

The machine (200) of this example is similar in most aspects to the machine (100) described above and the differences can be identified by comparing at least FIGS. 6 and 7 with FIGS. 13 and 14. In FIGS. 13 and 14, the features that are similar to those shown in FIGS. 1 to 12 are identified with the same reference numeral, incremented by 100. Most of the description of the machine (100) of the first example above, equally applies to the machine (200) and therefore need not be described again in detail.

The machine (200) is not a mower but a prime mover having a utility deck (208). The utility deck (208) may be utility deck that is suitable for the operation that the prime mover is configured to perform. One example of such an operation is a snow ploughing operation in which case machine may be a snow ploughing machine. The elevating device (210) comprising an actuator (214) and at least one tail wheel (212) is shown. The chassis (120) and the gap (208) between the first pair of drive wheels and the second pair of drive wheels are also shown. Only the drive wheel (204a) of the first drive wheel and the drive wheel (206a) of the second drive wheel can be seen in these views.

Other than any differences identified above and apparent from the drawings, the machine (200) is identical or substantially the same as the machine (100) described above, and therefore all or most of the description above relating to the machine (100) equally applies to the machine (200).

### Variations

To those skilled in the art to which the invention relates, many changes in construction and widely differing embodiments and applications of the invention will suggest themselves without departing from the scope of the claims. The disclosures and the description herein are purely illustrative and are not intended to be in any sense limiting.

Although, the example shows embodiments with four drive wheels, in some embodiments the machine may comprise more than four drive wheels.

Although the invention has been primarily described with reference to a mower, the machine (100) can be adapted for use in many other similar machines or similar weight, such as, but not limited to, snow ploughs and prime movers for snow ploughs, landscaping equipment etc. Typically, such machines may have the weight of 1000 kg or below.

Aspects of the present invention have been described by way of example only and it should be appreciated that modifications and additions may be made thereto without departing from the scope thereof.

### ADVANTAGES

Some non-limiting advantages of the present invention may include the following:
Addressing the challenges of maintaining traction while driving up slopes and enhancing flotation on wet ground, all while ensuring the machine remains compact and highly manoeuvrable for efficient day to day operations.
By locating the seat above the front drive wheels and the engine above the rear drive wheels can balance the centre of mass, significantly improving traction on slopes and reducing the risk of slippage.
Weight distribution over four drive wheels can lower ground pressure, stopping the machine from sinking into wet ground and reducing turf damage, while keeping it compact and easy to manoeuvre.
Minimising the gap between the drive wheels can allow for tighter turns, making the machine easier to manoeuvre in everyday mowing and to navigate precisely around obstacles and can help prevent damages to the turf.
Separating the seat from the engine can reduce exposure to vibrations and noise, increasing operator comfort during extended use. Additionally, the front-mounted utility deck further can decrease exposure to vibrations.
The rear-mounted elevating device can allow the tail wheel to lift the second pair of drive wheels off the ground, thereby reducing friction and surface damage during zero turn manoeuvres. It can transfer the weight distribution to the front drive wheels and rear tail wheel, ensuring better traction and control especially on slopes, and can enable sharper turns especially for mowing, snow ploughing or similar operations requiring precision.

1. A zero turn radius (ZTR) machine, the machine comprising:
a chassis comprising a front end portion and a rear end portion, the front end portion is oriented in a direction of forward movement of the machine and the rear end portion is oriented in an opposite direction;
a first pair of drive wheels rotatably mounted at or near the front end portion or a forward central region of the chassis;
a second pair of drive wheels rotatably mounted at or near the rear end portion or a rearward central region of the chassis, wherein there is a gap between the first pair of drive wheels and the second pair of drive wheels for allowing zero turn radius operation on the machine; and
an elevating device mounted at or near the rear end portion of the chassis, the elevating device comprising at least one actuator for selectively transitioning between a retracted position and an extended position, the elevating device further comprising at least one tail wheel operatively connected to the at least one actuator;
wherein, when in the retracted position, the at least one tail wheel is configured to be physically disengaged from a surface on which the first pair of drive wheels and the second pair of drive wheels are supported, while both the first pair of drive wheels and the second pair of drive wheels are configured to remain in contact with the surface; and
wherein, when in the extended position, the at least one tail wheel is configured to be physically engaged with the surface and positioned behind the first and second pairs of drive wheels, raising the second pair of drive wheels from the surface, thereby allowing the machine to operate in a zero turn radius mode with the at least one tail wheel and the first pair of drive wheels remaining in contact with the surface.

2. The zero turn radius (ZTR) machine as claimed in claim 1, wherein at least speed of each wheel of the first pair of drive wheel and each wheel of the second pair of drive wheel are independently controllable to allow the machine to operate in a zero turn radius mode even when the elevating device is in the retracted position.

3. The zero turn radius (ZTR) machine as claimed in claim 2, wherein the machine comprises individual motors for each wheel of the first pair of drive wheels and the second pair of drive wheels, and at least one controller that is operatively connected to the individual motors to control the direction and/or speed of each wheel of the first pair of drive wheels and the second pair of drive wheels.

4. The zero turn radius (ZTR) machine as claimed in claim 1, wherein the elevating device is mounted at or near the rear end portion of the chassis, such that when in the extended position, the second pair of drive wheels is configured to be located between the first pair of drive wheels and at least the at least one tail wheel that engages with the surface.

5. The zero turn radius (ZTR) machine as claimed in claim 1, wherein the at least one tail wheel is rotatably mounted to the at least one actuator.

6. The zero turn radius (ZTR) machine as claimed in claim 1, wherein the at least one tail wheel is configured to be positioned centrally behind the first and second drive wheels.

7. The zero turn radius (ZTR) machine as claimed in claim 1, wherein the gap or maximum gap between the first pair of drive wheels and the second pair of drive wheels is less than a tire diameter of any of the drive wheels, or less than a rim diameter of any of the drive wheels, or less than a tire width of any one the drive wheels.

8. The zero turn radius (ZTR) machine as claimed in claim 1, wherein the gap or maximum gap between the first pair of drive wheels and the second pair of drive wheels is 10 mm, 15 mm, 20, mm, 30 mm, 40 mm, between 10 mm and 40 mm, between 15 mm and 30 mm, or between 20 mm and 30 mm.

9. The zero turn radius (ZTR) machine as claimed in claim 1, wherein during a straight and forward movement of the machine, a rotational axis of the first pair of drive wheels is parallel to a rotational axis of the second pair of drive wheels.

10. The zero turn radius (ZTR) machine as claimed in claim 1, wherein size of the first pair of drive wheels is same or substantially the same as size of the second pair of drive wheels.

11. The zero turn radius (ZTR) machine as claimed in claim 1, wherein the first pair of drive wheels or the second pair of drive wheels are drivable by a chain drive mechanism or a belt drive mechanism.

12. The zero turn radius (ZTR) machine as claimed claim 1, wherein the machine further comprises a utility deck that is mounted to the chassis and is positioned in front of the first pair of drive wheels and the second pair of drive wheels.

13. The zero turn radius (ZTR) machine as claimed in claim 12, wherein the utility deck is mounted to the chassis by at least one arm and the at least one arm is spring loaded to pivot and transfer at least some weight from the utility deck to the first pair of drive wheels.

14. The zero turn radius (ZTR) machine as claimed in claim 12, wherein the utility deck is positioned in front of and below the chassis and is pivotally mounted to at least one arm that is connected to the chassis, with a spring or a gas strut exerting a pulling force on the at least one arm to partially lift the utility deck, thereby transferring or redistributing weight towards the first pair of drive wheels that are front drive wheels and reducing the load on the second pair of drive wheels that are rear drive wheels.

15. The zero turn radius (ZTR) machine as claimed in claim 1, wherein the ZTR machine further comprises at least one swivel wheel that is rotatably mounted to a front end portion of the utility deck for further facilitating the manoeuvrability of the machine.

16. The zero turn radius (ZTR) machine as claimed in claim 15, wherein the at least one swivel wheel is rotatably mounted to the front end portion of the utility deck on a vertical axis to allow for 360 degrees rotation of the at least one tail wheel.

17. The zero turn radius (ZTR) machine as claimed in claim 1, wherein the ZRT machine is a mower.

18. The zero turn radius (ZTR) machine as claimed in claim 17, wherein the mower is a ride on mower.

19. A zero turn radius (ZTR) mower comprising:
a chassis comprising a front end portion and a rear end portion, the front end portion is oriented in a direction of forward movement of the prime mover and the rear end portion is oriented in an opposite direction;
a first pair of drive wheels rotatably mounted at or near the front end portion or a forward central region of the chassis;
a second pair of drive wheels rotatably mounted at or near the rear end portion or a rearward central region of the chassis, wherein there is a gap between the first pair of drive wheels and the second pair of drive wheels for allowing zero turn radius operation of the machine;
an elevating device mounted at or near the rear end portion of the chassis, the elevating device comprising at least one actuator for selectively transitioning between a retracted position and an extended position, the elevating device further comprising at least one tail wheel operatively connected to the at least one actuator;
wherein, when in the retracted position the at least one tail wheel is configured to be physically disengaged from a surface on which the first pair of drive wheels and the second pair of drive wheels are supported, while both the first pair of drive wheels and the second pair of drive wheels are configured to remain in contact with the surface; and
wherein, when in the extended position the at least one tail wheel is configured to be physically engaged with the surface and positioned behind the first and second pairs of drive wheels, raising the second pair of drive wheels from the surface, thereby allowing the mower to operate in a zero turn radius mode with the at least one tail wheel and the first pair of drive wheels remaining in contact with the surface; and
wherein the mower further comprises a utility deck that is a mower deck mounted to the chassis and is positioned in front of the first pair of drive wheels and the second pair of drive wheels, the mower deck being mounted to the chassis by at least one arm that is spring loaded to pivot and transfer at least some weight from the mower deck to the first pair of drive wheels.

20. A zero turn radius (ZTR) machine, comprising:
a chassis comprising a front end portion and a rear end portion;
a first pair of drive wheels mounted at or near the front end portion or a forward central region of the chassis;
a second pair of drive wheels mounted at or near the rear end portion or a rearward central region of the chassis; and
an elevating device mounted near the rear end portion of the chassis, the elevating device comprising at least one actuator and at least one tail wheel operatively connected to the at least one actuator;
wherein the actuator is configured to transition the elevating device between a retracted position, where the at least one tail wheel is configured to be disengaged from a surface that is a supporting surface, and an extended position, where the at least one tail wheel is configured to be engaged with the supporting surface and the second pair of drive wheels lifted from the supporting surface, enabling zero turn radius operation with the first pair of drive wheels and the at least one tail wheel in contact with the surface.
